(19) United States
(12) Patent Application Publication
(10) Pub. No.: US 2002/0091824 A1
(43) Pub. Date: Jul. 11, 2002

(54) Intermediate systems for enterprise management from a central location

(75) Inventors: Jeff B. Anderson, Alpine, UT (US); Kevin D. Goertzen, Orem, UT (US); Cody K. Lowder, South Jordan, UT (US)

Correspondence Address: Daniel P. McCarthy, PARSONS, BEHLE & LATIMER, 201 South Main Street, Suite 1800, P.O. Box 45898, Salt Lake City, UT, 84145-0898, US

(73) Assignee: Center 7, Inc.

(21) Appl. No.: 10/044,114

(22) Filed: Jan. 10, 2002

Related U.S. Application Data
(60) Provisional application No. 60/260,970, filed on Jan. 10, 2001.

(51) Int. Cl. G06F 15/16; G06F 15/173

(52) U.S. Cl. 709/225; 709/203

(57) ABSTRACT

A computer system in communication with a central enterprise management facility having the functions of receiving enterprise device status and communicating that status to the facility. That computer system also having translation functions from protocols used by enterprise devices to and from the protocol of the facility. That computer system also having filtering functions whereby only interesting status information is communicated to the facility. That computer system also having the functions of receiving requests for enterprise device status from the facility and responding with such status. That computer system being housed in a cabinet whereby access is restricted to the system components. That computer system having a security camera. That computer system having means of detecting extremes of temperature. That computer system having means of communication with the facility over a secure or encrypted channel. That computer system having a controller whereby internal servers may be powered on and off. That computer system with means of discovering the enterprise devices in an enterprise. That computer system with means of upgrading software to the enterprise devices. That computer system with an enterprise. That computer system with a central enterprise management facility.

### CROSS-REFERENCE TO RELATED APPLICATIONS

This application claims the benefit of U.S. Provisional Application No. 60/260,970 filed Jan. 10, 2001.

### BACKGROUND OF THE INVENTION

The present invention relates generally to management of enterprise systems and more particularly to management of multiple enterprise systems from a central location through the use of an intermediate computer system which facilitates reporting conditions in and maintaining an enterprise.

The rise of the Internet has brought new forms of business. These businesses use networked computers and the Internet to supplement, and in some cases supplant, older forms of communication, accounting, news delivery, and many other kinds of activities. Such a group of interconnected computer and electronic resources serving a business purpose are referred to as an enterprise.

Today there are many businesses exposed to interruption of business activity and significant financial losses in the event networks and computer systems fail. For many years enterprises remained small, thus skilled persons could be hired to monitor the operation of these systems to lessen the likelihood and effects of such failure. Today's enterprise systems sometimes contain a hundred or more individual components, often spread in different locations across a country or the world. It becomes cost-prohibitive to train and hire the staff needed to monitor such an operation. This situation has led to a realization that software is needed to assist these operators in monitoring and maintaining their enterprises.

Software which assists operators to monitor and maintain enterprises is referred to as enterprise management software. In its essence, this software collects status reports from the devices comprising the enterprise, interprets information therein, and organizes the information into a readable form. The software presents this information to an operator in some fashion, often by way of a web browser. There may also be software components, called agents, installed to the enterprise devices and network which monitor portions of the enterprise and send status reports to be collected. Other functions are sometimes performed by enterprise management software, including scanning networks for compatible devices and agents, job scheduling, backups, and system performance analysis and prediction.

Common transports for such status reports are Simple Network Management Protocol (SNMP) and Common Management Information Protocol (CMIP). These standard transports provide methods of communicating the state of network-enabled devices to other interconnected computers. SNMP may be implemented over the Internet Protocol (IP), which is supported by most current networks. SNMP version 1 is by far the most commonly used network management protocol at the time of this writing, with many vendors of network products providing SNMP functionality as an important product feature.

Speaking in general terms, the SNMP protocol communicates the status of network devices in messages called protocol data units, or PDUs. In normal operation, when it is time to query the status of a device the network management software will submit a “get” request to the network device encapsulated in a PDU. The network device responds with a single value representing the device status encapsulated in a separate PDU. If successive responses are required to collect further information, the network management software will submit a “get next” request, which is responded to by the device sending successive values each encapsulated in separate PDUs. A “set” PDU may be sent to a device to set a variable to a value. And lastly a “trap” PDU may be sent to a listening entity from a device indicating a transition in the state of the device.

SNMP uses a configuration database known as a management information base, or MIB. In essence, the MIB contains information of each managed device including such things as a list of capabilities and variables and the address by which the device may be reached. The address of each device is composed of a unique object identifier, or OID. A managing program, such as the enterprise management software, may reference the MIB to gather what devices are accessible, what information may be requested, how to request that information, and where a device may be addressed on the network.

Current enterprise management software not only permits communication of the state of devices in an enterprise to a user, but also may execute actions under some conditions. Instructions to execute upon recognition of a particular state are known as policy. For example, it might be helpful to notify a network administrator if a web server becomes inoperative. Policy for such a situation would include the condition of the web server being unreachable, and the instructions to email a problem report and page the network administrator. Other examples where policy might also be useful would be to notify an administrator if a hard disk on a server is nearly full, or to restart a network router if the network becomes unreachable.

There are a number of such enterprise management software packages currently available. These include Unicenter TNG by Computer Associates of Islandia, N.Y., OpenView by Hewlett Packard of Palo Alto, Calif., Tivoli by Tivoli Systems Inc. of Austin, Tex., and others. These products have matured and continue to develop.

There are a number of limitations with existing enterprise management systems. First, they require an uncommon expertise. Current educational and training standards do not encompass the use of available enterprise management software, and such skills are not recognized as notable for those in the computer field. Thus a business wishing to establish an enterprise must expend time and money to train staff to set up these management systems. Additionally, this staff must be retained in the employ of the business to maintain the enterprise, incurring further expense.

Second, sometimes it is desired to monitor a critical software application that does have support for standard network management. Such an application might be a new product for which network management functions have yet to be written, or a legacy product no longer in development. In such cases a sort of “glue” application must be written which monitors the application and reports status to the network management. Businesses have no incentive to share these specialized applications with other businesses, so each business must expend more time and money to develop these glue applications.

Third, further duplication of effort occurs when businesses implement policy. Many enterprises utilize similar components, such as web servers and databases. The policy for such similar components will be largely the same across different enterprises. For example, an administrator will normally need to be notified using the swiftest means in the event the main web server crashes. Thus the policy for most web servers will reflect that the administrator be paged upon detection of catastrophic malfunction of the main web server. Administrative staff across organizations are likely to implement similar policy for many types of network devices, but as there is no reliable method of sharing policy further redundant effort will be expended in generating and perfecting policy.

Fourth, these businesses do not benefit from testing of these glue applications and policy beyond the use of their own enterprises. It is well recognized that a large pool of testers is more likely to discover the bugs in a system than a small pool. Applications and policy in wide use would be more fully tested and reliable.

Fifth, some enterprise software packages contain applications which predict future enterprise state, and report such predictions to the enterprise maintainers. As such software encompasses a single enterprise, the predictions are limited to input data of only one enterprise, which may be an inadequate predictor. One enterprise may have experienced failures similar to what may occur in a second enterprise, but predictions cannot be asserted for the second enterprise using data from the first with the present state of the art systems.

Thus it follows from this and other reasons there is a need for a way to configure and operate enterprise management systems by a single expert administrative entity to reduce the administrative and financial burdens on the owners of such systems thereof.

### BRIEF SUMMARY OF THE INVENTION

The invention provides systems that facilitate remotely managing multiple enterprises from a central location. In a preferred embodiment of the invention a computer system called a reporting and maintenance system (RMS) is provided that acts as an intermediary between the devices of an enterprise and a central management facility. In that embodiment the RMS receives the status of enterprise devices and communicates this status to the central management facility, such communication usually being over the Internet. That RMS may deliver the status on several events, such as a change in the state of an enterprise device or on request from the central management facility.

Additional objects, advantages, and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described the preferred embodiments of this invention, simply by way of illustration of one of the modes best suited to carry out this invention. As it will be realized, this invention is capable of other different embodiments, and in its several details it is capable of modification without departing from the concept of the invention. Accordingly, the drawings and descriptions should be regarded as illustrative in nature and not as restrictive.

### BRIEF DESCRIPTION OF THE SEVERAL VIEWS OF THE DRAWINGS

The accompanying drawings incorporated in and forming a part of the specification, illustrate a preferred embodiment of the present invention. Some, although not all, alternative embodiments are described in the following description. In the drawings:

FIG. 1 illustrates the high-level interconnectivity of a system of the invention.

FIG. 2 illustrates a high-level logical representation of a system of the invention.

FIG. 3 illustrates one embodiment of a system of the invention incorporating a reporting and maintenance system.

FIG. 4 illustrates a second embodiment of a system of the invention incorporating a reporting and maintenance system.

FIG. 5 illustrates a third embodiment of a system of the invention incorporating a reporting and maintenance system having two servers for redundancy.

FIG. 6 illustrates a system of the invention incorporating a reporting and maintenance system having elements for monitoring and securing the reporting and maintenance system.

FIG. 7 shows external physical elements of a preferred embodiment of a reporting and maintenance system.

FIG. 8 shows internal physical elements of a preferred embodiment of a reporting and maintenance system.

FIG. 9 illustrates a method whereby messages from enterprise devices may be reported with respect to priority.

Reference will now be made in detail to the present preferred embodiment of this invention, an example of which is illustrated in the accompanying drawings.

### DETAILED DESCRIPTION OF THE INVENTION

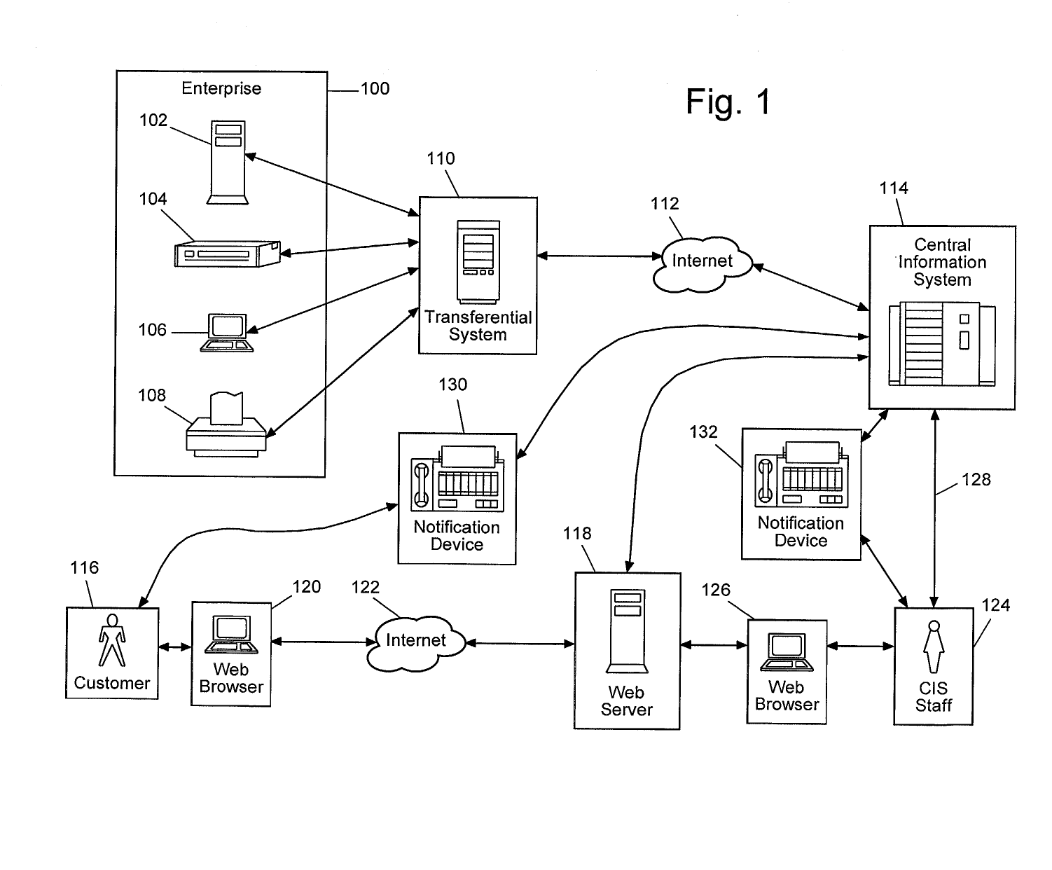

FIG. 1 illustrates by example the high-level interconnection of a system of the invention. Enterprise 100 includes a set or subset of networked computer and electronic devices serving a business purpose which are deemed necessary to be monitored and maintained. Such networking would normally be encompassed by a local area network (or LAN), although super-LAN implementations are possible if sufficient bandwidth is provided. Examples of networked computer and electronic devices are shown as a server 102, a disk array 104, a workstation 106, and a network enabled printer 108. For the purposes of this writing, a network enabled object is an object that may be configured to be controlled or communicate status over a network. Such computer and electronic devices may include any other device which can be networked into enterprise 100.

Transferential system 110 is a computer system connected to devices shown by example as 102, 104, 106, and 108 with software to communicate status and status requests between the devices and the central information system 114 through a network connection 112, which is shown by way of example as the Internet. Examples of other connections which can be used are virtual private network connections and private network lines. Transferential system 110 is located in communicative proximity to the devices so as to permit sufficient bandwidth for communication to the devices at a low cost. One embodiment of the invention communicates status messages initiated by a device when specific events are encountered. The messages are sent to transferential system 110 which are forwarded to central information system 114. Examples of specific events are a timer expiring, and an error condition encountered. Another embodiment of the invention communicates device status by central information system 114 sending a status request message destined for a designated device through transferential system 110, which message is responded to by the designated device, if the state of the designated device allows, back to central information system 114 through transferential system 110. Transferential system 110 may also contain software to execute policy instructions on receipt of status messages from the devices. One or more transferential systems 102 may be used per LAN, as may be required if enterprise 100 spans multiple LANs or to improve the message throughput between the devices and the central information system 114.

Central information system 114 is one or more computers having enterprise management software installed thereon to receive and maintain state information of devices shown by example as 102, 104, 106, and 108 in enterprise 100. Central information system 114 facilitates monitoring and maintaining multiple enterprises 100. Central information system 114 may further contain software to execute policy instructions stored in memory contained within central information system 114. Central information system staff 124 manage the operation of central information system 114. Communication utility 128, such as a terminal, may be provided between central information system 114 and central information system staff 124 for monitoring and maintaining central information system 114. Central information system 114 is separable, with respect to physical locality, from enterprise 100 and transferential system 110 provided that network connection 112 provides sufficient bandwidth for communication to and from transferential system 110. In a typical embodiment, central information system 114 is operated by a managing party including central information system staff 124 different than those parties operating multiple enterprises 100. In that embodiment, the managing party may monitor and manage enterprises 100 through central information system 114.

A presentation server system 118, shown by way of example as a single web server, is provided to allow state information received by central information system 114 to be presented in a humanly readable format. A customer 116 may view the state of his enterprise 100 by accessing presentation server system 118 through local application software 120, shown by example as a web browser, through a network 122, which is shown by example as the Internet. Central information system staff 124 may also access enterprise state information through presentation server system 118 through local application software 126, also shown by example as a web browser. Presentation server system 118 may also provide a user interface for configuring central information system 114 and other functions as desired. Presentation server system 118 may comprise multiple servers as desired which may, among other purposes, serve the purpose of reducing network congestion or improving response time.

Central information system 114 may contain policy instructions which notify a customer 116 or central information system staff 124 of enterprise status by way of a notification message. Notification device 130 and notification device 132 are provided to notify customer 116 and central information system staff 124, respectively, of such status. Examples of notification devices are a telephone message system, a paging system, and an email system. Two notification devices 130 and 132 are shown by way of example; one or more notification devices are necessary to provide notification messages to customers 116 and central information system staff 124. Notification devices 130 and 132 may incorporate methods for customer 116 and central information system staff 124 to submit a response or acknowledgment message to a notification message to central information system 114. Notification devices 130 and 132 may report the results of a notification attempt to central information system 114 which may cause further execution of policy. Presentation server 118 and communication utility 128 may also provide a mechanism by which response or acknowledgment messages may be returned to central information system 114.

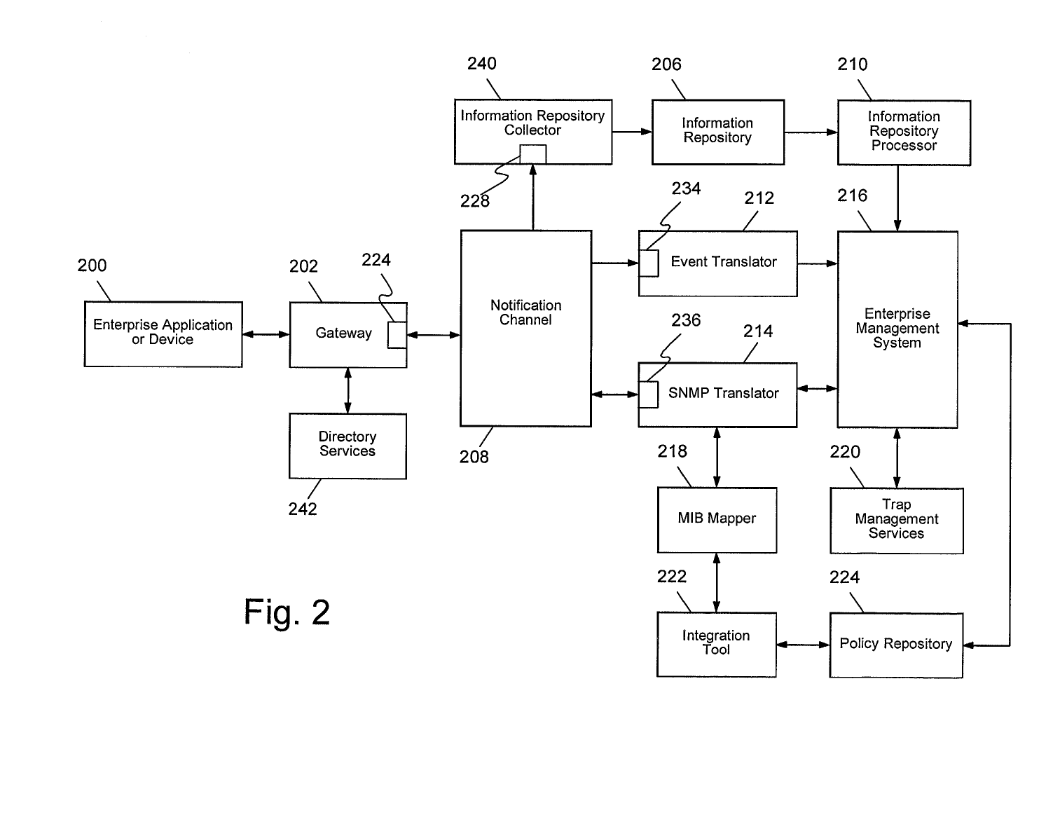

FIG. 2 illustrates a high-level logical representation of a system of the invention. A network enabled device 200, or a software application executing on that device, is to be monitored as a component of an enterprise. Examples of such devices are servers, workstations, network appliances and network printers as mentioned in connection with enterprise 100 from FIG. 1. Device 200 reports status information messages to a gateway 202 using a particular protocol, two examples of protocols being HTTP and TCP socket based protocols. Such messages may be initiated by an event, such as a timer expiring or an error condition, or by a status request message from gateway 202.

Gateway 202 is a software system which serves as an interface between enterprise device 200 and notification channel 208. Gateway 202 translates messages in the particular protocol used by device 200 to the notification channel protocol used by notification channel 208, and vice versa. In one embodiment gateway 202 retrieves operational configuration from directory services 242, described below. Gateway 202 subscribes to notification channel 208 using a filter that selects only devices 200 which are logically connected, such subscription being described below. Gateway 202 receives messages destined for device 200, such messages containing a unique identifier for the device 200. When such a message is placed in notification channel 208, gateway 202 extracts the message, translates the message to the particular protocol used by device 200, and transmits the translated message to device 200. Gateway 202 also listens to device 200, receiving and translating messages therefrom and placing translated messages into notification channel 208 using the notification channel protocol, described below.

A message in the notification protocol must contain at least two information fields. One required field is an identifier for the sender. The other required field is a substantive message that is meaningful to the destination. In a preferred embodiment a service identifier and security token is provided, whereby the message may be authenticated against a number of service types. In that preferred embodiment a severity declaration is also provided, whereby messages of higher importance may be specially treated. Optional fields may contain the time the message was generated or created, the time the message was received at the destination, the subsystem that originated the message, the object oriented method that originated the message, and a plain text error message. Optionally an SNMP OID may be contained in the message to facilitate delivery to the destination. In a preferred embodiment an original SNMP message is wrapped into a notification protocol message by including the SNMP message in the substantive message field.

Notification channel 208 provides message routing and transport facilities for messages coming to and from managed devices 200 through gateways 202. Communicative objects, such as gateways 202 or SNMP translator 214, may place messages into the notification channel 208, where they are forwarded to one or more other communicative objects, such as gateways 202, information repository 206, and event translator 212. In order to receive messages from notification channel 208, a communicative object must subscribe to the notification channel 208 with a filter criteria. After such subscription a communicative object will then be notified when a new message is available for retrieval from notification channel 208 within the bounds of the filter criteria. In a preferred embodiment of the invention notification channel 208 provides a short term storage for retaining passing messages. In that embodiment a mechanism of discarding old messages to make room for new messages in memory storage should also be provided. Notification channel 208 also implements facilities to retrieve subsets of the contained messages based on filter criteria. The system of the invention may have one or more notification channels 208 as desired for organizational purposes. Notification channel 208 may also implement an authentication scheme whereby communicative objects must be authenticated before placing or retrieving messages from notification channel 208.

Communication to and from notification channel 208 is provided in a preferred embodiment by regular connectors 224, 228, 234 and 236. CORBA (Common Object Request Broker Architecture) is a software specification that provides a framework for sharing objects in a distributed computing environment, which provisions may be utilized in regular connectors to provide a simple method of passing messages and other information to different networked computers within the system of the invention. In a preferred embodiment regular connectors are implemented using the CORBA specification, which are then referred to as CORBA connectors. One embodiment of a regular connector consists of two unidirectional channels through which messages may pass. Each channel consists of software for receiving messages, software for transmitting messages, and a queue where messages may be stored after receipt but before transmission. Two channels operating in opposite directions provide bi-directional communication. Another embodiment of a regular connector consists of four unidirectional channels. Two pairs of unidirectional channels operating in opposite directions form two bi-directional channels, one pair for low priority and the other pair for high priority messages. Regular connectors may be useful for communication in other parts of the invention and may be included where desired. Persons skilled in the art will recognize that communication as provided by these regular connectors may be implemented in many possible ways; thus inclusion of regular connectors is not required to practice all systems of the invention.

Enterprise management system 216 is one or more computers with enterprise software installed thereon performing at least the tasks of communication with devices 200 in a device management protocol, such as SNMP, and providing an interface by which persons may be presented the state of an enterprise. In an alternative embodiment, enterprise management system 216 also contains facilities to execute policy. Enterprise management system 216 in a preferred embodiment is referred to as the Master Stack.

Event translator 212 is a software system that subscribes to and receives messages from notification channel 208 using a filter to receive those messages that need to be communicated to the enterprise management server 216 soon after those messages are placed in the notification channel. Such messages are normally initiated by devices 200, without a status request message being sent to them. Such messages may be initiated by an event, such as a timer expiring or an error condition. When the presence of such a message is detected by event translator 212 in notification channel 208 the message is received therefrom, translated to one or more messages in the protocol used by enterprise management system 216, and those translated messages communicated to the enterprise management system 216 which may trigger the execution of policy. For example, a server device 200 may have run out of disk space. Server device 200 would then send a message to gateway 202, the message being marked with a flag indicating urgency. Gateway 202 would then translate the message into the notification protocol and place the translated message into notification channel 208. Event translator 212, in this example having subscribed to notification channel 208 with a filter to detect only messages with the urgent flag set, detects and receives the message from notification channel 208. Event translator 212 then translates the message into SNMP and transmits the translated message to enterprise management system 216. Enterprise management system may then execute policy to notify the central information system staff and the customer of the problem.

SNMP translator 214 is a software system that receives request messages for a particular device 200 from enterprise management system 216 using the enterprise management system protocols, SNMP being one possible protocol. Such request messages may include, but are not restricted to, requests to configure device settings and requests for status information. The request message is converted into one or more messages in the notification channel protocol, intending to cause a response from the particular device 200 with the information required by the request message. Such conversion is facilitated by information from MIB mapper 218. The converted messages are placed into notification channel 208, and received by a gateway 202 subscribed to receive messages for the particular device. Gateway 202 translates each message into the protocol used by the particular device 200 and transmits them thereto. If in condition to respond, the particular device 200 then submits a response for each message to SNMP translator 214 through gateway 202 and notification channel 208. SNMP translator 214 then builds and submits a response to the original request message to enterprise management system 216 in the protocol used thereto.

For example, a customer may call up a display of a portion of his enterprise system. Enterprise management system 216, which uses the SNMP protocol, will send status requests for each device 200 to be displayed. SNMP translator will receive each status request message, translate each message from SNMP to messages in the notification channel protocol, place those messages in the notification channel, wait for and receive the responses from the notification channel, translate the responses back to SNMP and transmit those response messages to the enterprise management system 216.

SNMP translator 214 may also contain state information associated to devices 200, such that requests to configure or read the state of a device 200 may be responded to in an expected fashion to enterprise management system 216, expecially if those requests are not meaningful for device 200.

MIB mapper 218 is a software tool that provides conversion information to convert messages in the enterprise management system protocol to messages in the notification channel protocol and vice versa. MIB mapper 218 contains a database of such conversion information, and may also contain facilities for entry and editing of such conversion information. Conversion information specifies the functions of conversion of the device identifier, or device address, and the conversion of particular kinds of request and response messages.

Trap management services 220 is a software system, shown connected to and serving enterprise system 216 by example, supplying a contraindicating message after receipt of a trap message when the trap message is no longer indicative of the state of a device 200. A trap message, for the purposes of this writing, is a message that without external intervention will cause the enterprise management software to have a potentially perpetual incorrect representation of an enterprise device 200. For example, a device 200 has two states, normal state A and abnormal state B. On encountering an error condition the device goes from state A to state B and sends a status report to the enterprise management software noting this transition. Through administrative intervention or otherwise the device returns to state A, but without sending a new status report. There is no possible way for the representation of the device in the enterprise management system to return to normal state A automatically, and the enterprise management software will represent the device in abnormal state B perpetually until intervention is performed.

Trap management services 220 serves the purpose of noting and reporting transitions of state of devices 200, for devices 200 do not report these transitions themselves in self-initiated status messages. Trap management services 220 may poll the status of such devices 200, and send status messages in proxy of devices 200 to enterprise management system 216 to correct the device representation therein. Trap management services 220 may also be connected to and serve other system components which contain state representing the state of devices 200 such as notification channel 208.

Policy repository 224 is a database and software tool containing policies, possibly in various conditions. Generic policies may be included for typical configurations of devices 200. Generic policies may be extracted from policy repository 224, modified as required, and placed into service in the enterprise management system 216. Policy repository 224 may contain such extraction, modification, and placement facilities. Policy repository 224 may also contain divisions for policies which are trusted and distrusted, tested and untested, or other divisions as deemed necessary. Policy repository contains facilities to insert and extract policy into the contained database, and may also contain facilities to edit policies and to move policies from one division to another. Policy repository 224 may contain facilities for searching the policy database contained within and for modification of policies to suit a particular configuration of a device 200. Policy repository 224 may facilitate to recycle policies from within an enterprise, or across enterprises.

Integration tool 222 is a software system which assists a person to add an entry for a new device 200 to MIB mapper 218 and optionally create new policy for insertion to enterprise management system 216 for that new device 200. Integration tool 222 may contain facilities to search entries in a database containing information compatible with MIB mapper 218, and to insert new entries to MIB mapper 218. Integration tool 222 may also contain facilities to search the policy database in policy repository 224, or other policy database, and may also contain facilities for modification of policies and insertion of policies into policy repository 224 or enterprise management system 216.

Information repository 206 is a software system having the function of receiving messages from notification channel 208, having subscribed thereto with a broad filter capturing messages across multiple devices in one or more enterprises. Information repository 206 retains a historical message database composed of such messages over a longer period of time than the message persistence provided by notification channel 208, such period of time normally being longer than one week. The historical message database contained may be searched by external applications and provides an interface for searching and delivery of subsets of the historical messages based on filter criteria. Information repository collector 240 is a system that saves messages passing through notification channel 208 to information repository 206.

Information repository processor 210 is a software system having the function of retrieving historical messages from information repository 206, and performing analysis on those historical messages. Human readable reports may, but are not required to be, formed from such analysis. Information repository 206 is supplied with historical messages by information repository collector 240. Date warehouse collector 240 may optionally contain facilities to filter messages from notification channel 208 such that messages not required by information repository processor 210 are not saved to information repository 206. Information repository processor may predict the future state of devices 200 based on data contained within historical messages. Information repository processor 210 may deliver such prediction information to enterprise management system 216. Such information may be used to alert an administrator of an impending situation.

In one embodiment, directory services 242 provides facilities of access control to various components of the system of the invention. Directory services 242 may provide centralized authentication services for other components of the system such as gateway 202, thus restricting the entry or extraction of messages from notification channel 208. Directory services 242 may also provide configuration for gateways 202. Such configuration may optionally include a list of enterprise devices and applications 200, the number of communicative worker threads, and other configuration as desirable.

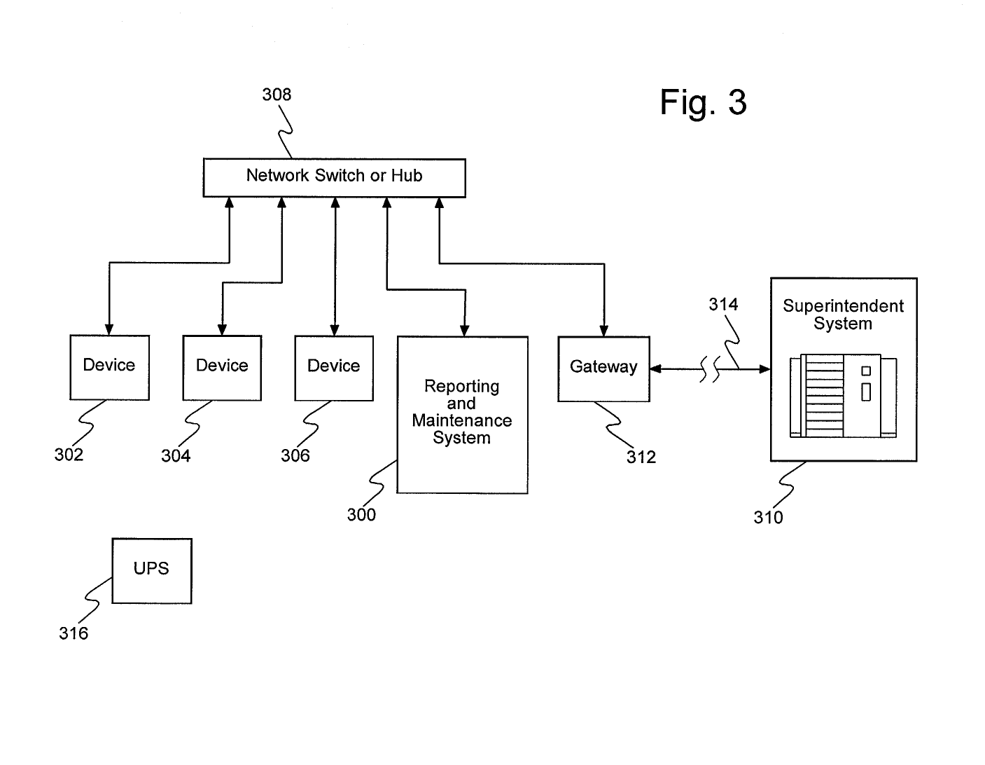

FIG. 3 illustrates by example a system of the invention. An enterprise includes devices, illustrated by example as 302, 304, and 306, which are shown by example interconnected in a 10baseT or 100baseT configuration by network switch or hub 308. Those skilled in the art will recognize that many network technologies may provide such network interconnectivity. Extra-LAN communications from the enterprise devices 302, 304, and 306 are enabled through a gateway 312. Reporting and maintenance system (RMS) 300 monitors the enterprise devices through network switch or hub 308, providing means of communication thereby. In embodiments of the invention an RMS is a transferential system of FIG. 1. RMS 300 is exemplified as a single computer, although the RMS may be composed of a number of computers, servers or other devices, examples of which are described below. At least one computer in RMS 300 contains a non-volatile memory device on which software is installed. One example of an RMS is the Cyberstack™ available from Center 7, Inc. in Lindon, Utah. In this example, RMS 300 communicates with superintendent system 310 facilitated by gateway 312 and network switch or hub 308. Network connection 314 from gateway 312 to superintendent system 310 may include other devices supplying interconnectivity such as modems, routers, etc. There are many possible implementations of the connection from RMS 300 and superintendent system 310; the network configuration shown is for example only. The system of the invention shown in FIG. 3 demonstrates a system whereby the RMS shares an extra-LAN connection with enterprise devices. An uninterruptable power supply (UPS) 316 may be included to mitigate the effects of a loss of electrical mains power. In one embodiment UPS 316 supplies power to RMS 300, network switch or hub 308, and gateway 312 ensuring communication to superintendent system 310 through a loss of power. A UPS may be included with other embodiments of the invention serving the purpose of mitigating power loss.

A superintendent system for the purposes of this writing is a system having enterprise management software installed thereon having the purpose of monitoring and maintaining multiple enterprises through the use of reporting and maintenance systems. A superintendent system may be composed of multiple computers and systems as desired. In systems of the invention superintendent systems provide human interfaces whereby the state of enterprises may be monitored and optionally controlled. The central information system shown in FIG. 1 is one example of a superintendent system.

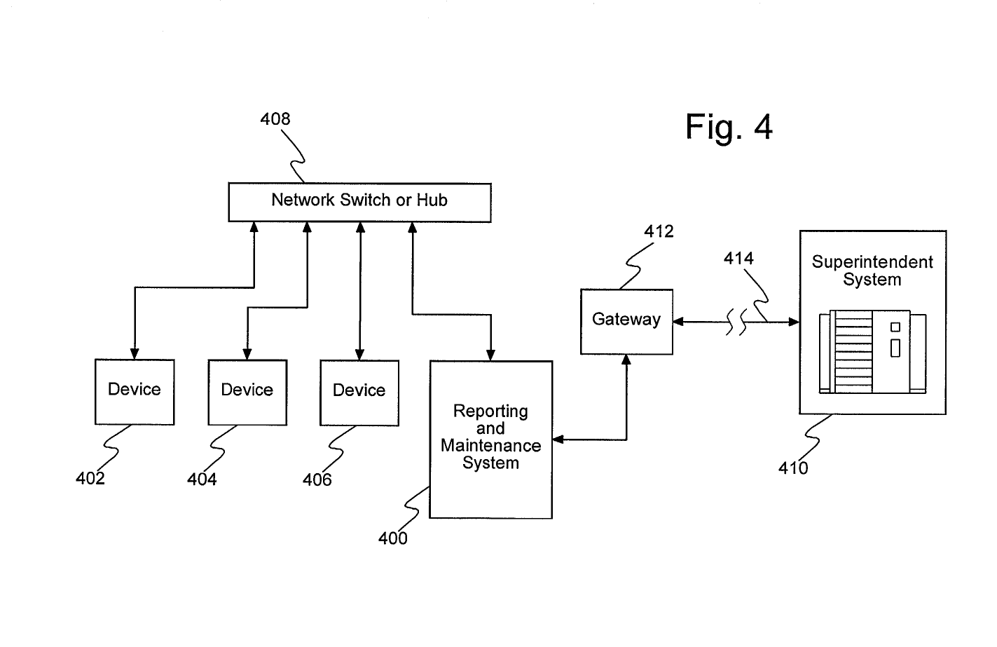

FIG. 4 illustrates by example a system of the invention whereby the RMS 400 communicates with superintendent system 410 though a communications channel exclusive to enterprise devices shown by example as 402, 404, and 406. Extra-LAN communications for enterprise devices may be provided as required, but are not shown. RMS 400 monitors the enterprise devices through network switch or hub 408, providing communication thereby. RMS 400 is exemplified as a single computer, although the RMS may be composed of a number of servers and other devices, examples of which are described below. RMS 400 communicates with superintendent system 410 facilitated by gateway 412. Network connection 414 from gateway 412 to superintendent system 410 may include other devices supplying interconnectivity such as modems, routers, etc. It will be recognized by those skilled in the art that the connection from RMS 400 and superintendent system 410 may be provided in many possible ways; the network configuration shown is for example only.

One embodiment of the invention provides a cache incorporated in an RMS by which messages from enterprise devices may be stored in the event network connection is temporarily disabled. In that embodiment messages are sent after detection of the end of the connection outage.

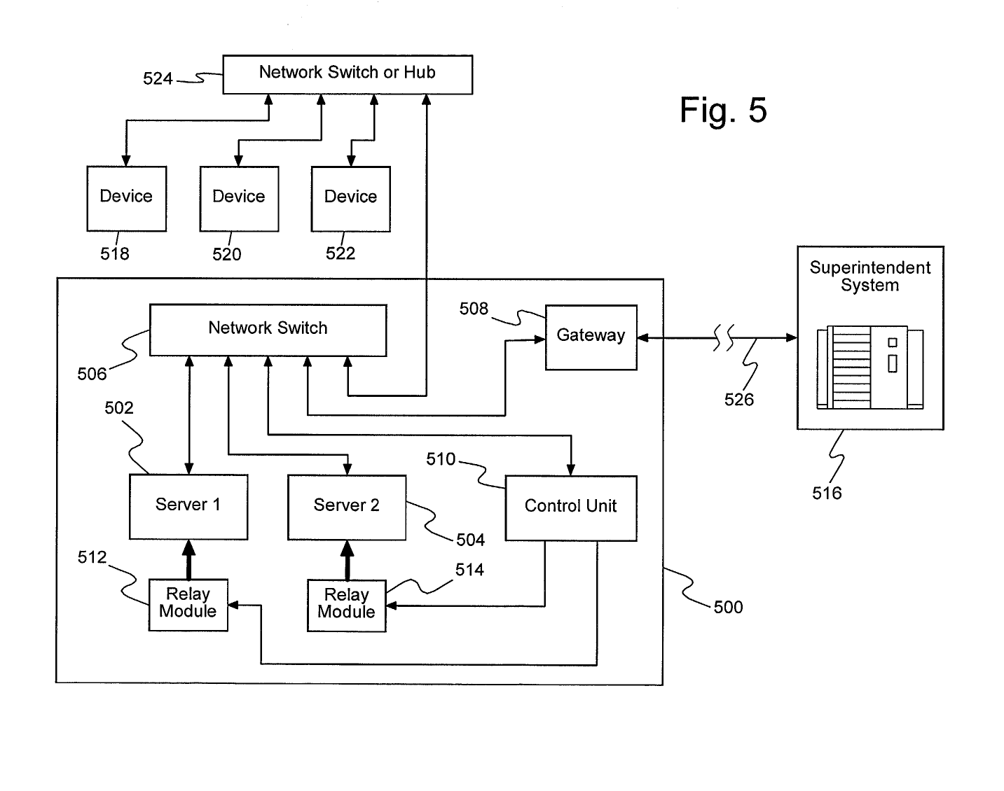

FIG. 5 illustrates by example another system of the invention. RMS 500 includes a number of components providing additional functionality to the systems described above. Servers, shown by example as two servers 502 and 504, contain software to monitor enterprise devices, shown by example as 518, 520, and 522. Servers 502 and 504 compose a server group providing redundancy to ensure continued service in the event of a single server failure. Additional servers may be provided to the server group providing additional redundancy as desired. Additional servers may also be included to provide additional processing power as necessary to process and forward messages to and from the enterprise devices. Network connectivity between servers 502 and 504 and the enterprise devices is facilitated by network switch 506 and network switch or hub 524 providing network communication thereby. Network switch 506 also provides a sub-net division with other components included in RMS 500, which are gateway 508 and control unit 510. Gateway 508 and network connection 526 provide a network connection from servers 502 and 504 to superintendent system 516 by way of network switch 506. An encrypted network connection may be provided from servers 502 and 504 to the superintendent system 516. Such encryption may be provided by using a virtual private network device (VPN) for gateway 508 and implementing a device or software providing a VPN counterpart for superintendent system 516. Control unit 510 is a network capable appliance accepting commands from superintendent system 516, by which power to servers 502 and 504 may be controlled through relay modules 512 and 514. A relay module is not restricted to be a relay, but may be any electronic device which controls current through an input signal designed to switch power at the voltage and current needed by the server connected thereto. Control unit 510 may also contain functionality to return status, such as the status of the control signals to relays 512 and 514.

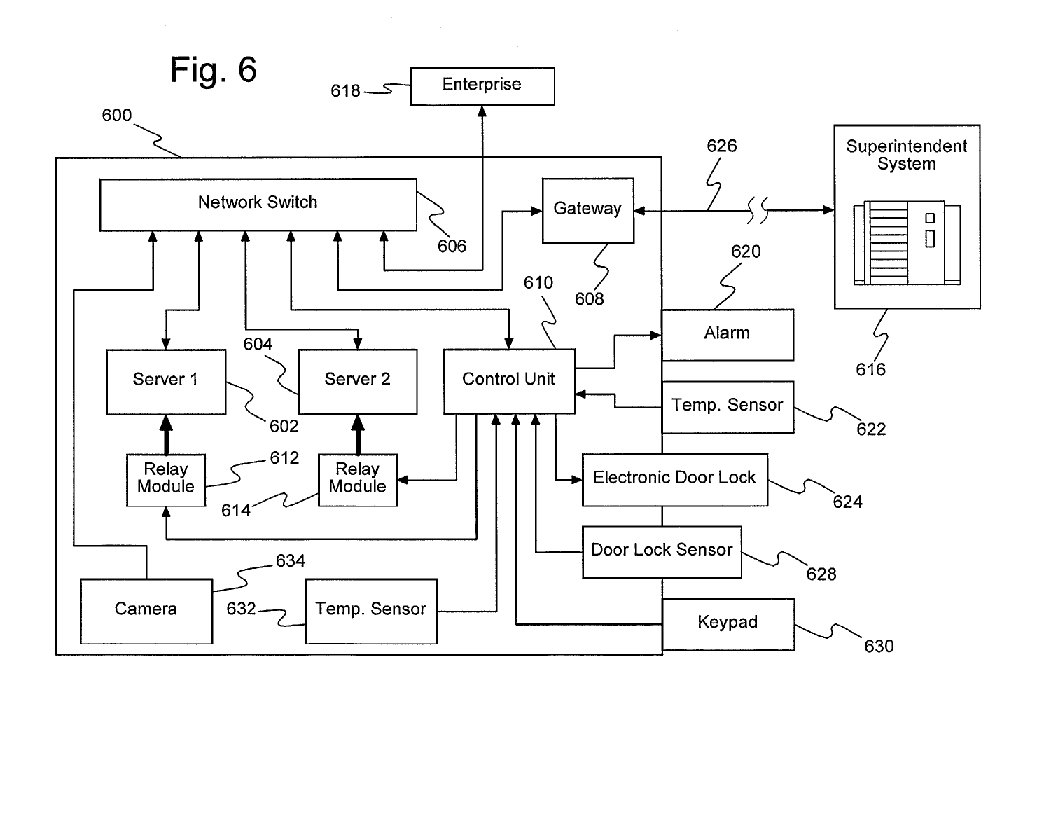

FIG. 6 illustrates by example another system of the invention. RMS cabinet 600 encloses a number of components, forming an RMS. Cabinet 600 houses the RMS components and also restricts access to those components. Cabinet 600 incorporates at least one door by which access to the RMS components may be granted. Servers, shown by example as two servers 602, and 604, contain software having the function of enabling the monitoring and management of enterprise devices in enterprise 618. Network connectivity between servers 602 and 604 and the enterprise devices is facilitated by network switch 606. Network switch 606 also provides a sub-net division with other components included in RMS 600, which are gateway 608 and control unit 610. Gateway 608 and network connection 626 provide a network connection from servers 602 and 604 to superintendent system 616 by way of network switch 606. Control unit 610 is a network capable appliance providing communications with superintendent system 616. Control unit 610 may accept commands from superintendent system 616, thereby controlling the various devices to which output lines are connected. Control unit 610 may also transmit the status of the various devices to which input lines are connected. Power to servers 602 and 604 may be controlled through relay modules 612 and 614, such relay modules not being restricted to relays only but to any electronic device with controls current through an input signal designed to switch power at the voltage and current needed by the server connected thereto. Alarm 620 is a device providing an audible signal to the exterior of cabinet 600 controllable through control unit 610, by which persons in the vicinity of the RMS may be notified of a condition requiring attention. Readings of temperature of the air exterior to cabinet 600 is provided to control unit 610 by temperature sensor 622, which readings may then be transmitted to the superintendent system. The cabinet door may be locked by way of electronic door lock 624. Lock 624 may be controlled by control unit 610, by which lock 624 may be disengaged allowing the cabinet door to be moved to an open configuration remotely. Lock 624 may also provide a mechanical disengagement device, permitting access under power loss or control unit failure conditions. Lock 624 is shown as a single lock for a single cabinet door; additional locks may be provided for additionally included cabinet doors. Door lock sensor 628 senses the cabinet door and door lock 624 condition, returning this status to control unit 610. A keypad 630 may also be included separately from electronic door lock 624 to provide coded access to the RMS components, especially if a keypad is not built in to door lock 624. Temperature sensor 632 is positioned such that readings of the air inside cabinet 600 may be provided to control unit 610. Camera 634 provides images to superintendent system 616 through gateway 608 and network switch 606, whereby visual security is provided.

It will be recognized by those in the art that network switch 606 is not an exclusive method of establishing network interconnectivity for the RMS components to each other, the enterprise devices, and the superintendent system; the illustration of network switch 606 shows one embodiment of the invention.

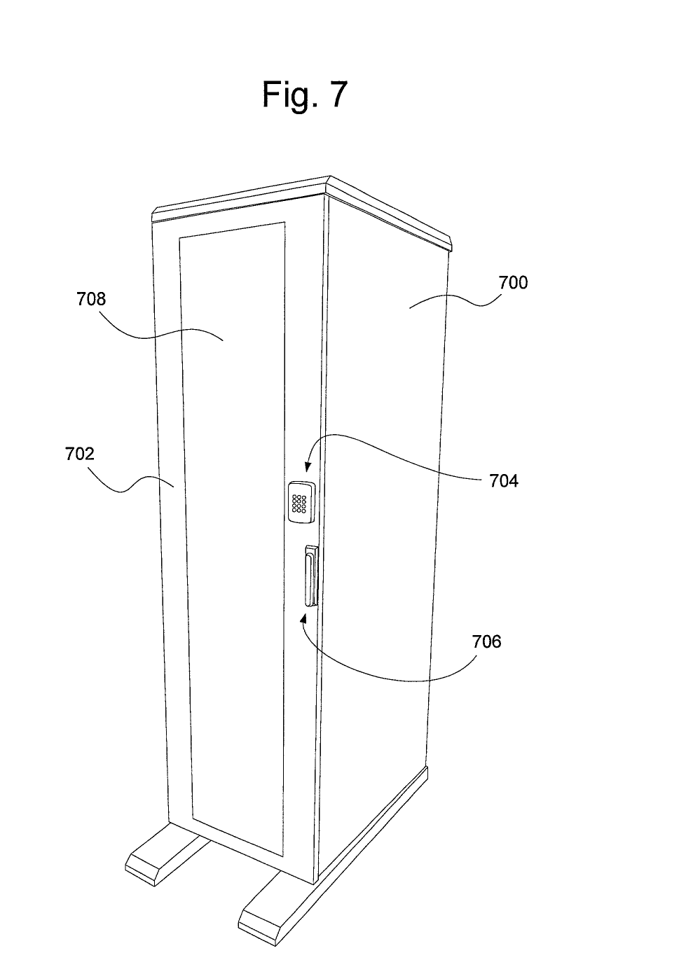

FIG. 7 illustrates an exterior view of a preferred embodiment of an RMS. Cabinet 700 provides protection and restricted access to enclosed internal components. Door 702 provides access to the internal components. Lockset and lever 706 provide mechanical means of locking door 702, whereby a key may be used to disengage the lockset. Keypad 704 provides authentication of entry, whereby access to the interior of cabinet 700 may be restricted without entry of a code. Transparent panel 708 is included in door 702 such that the internal components of the RMS may be viewed.

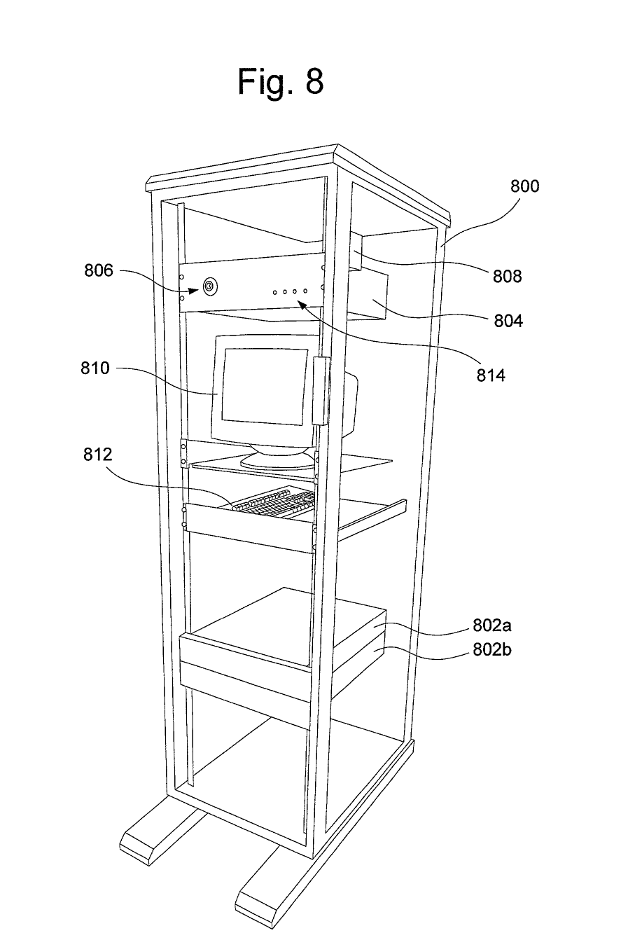

FIG. 8 illustrates an interior view of the embodiment of the RMS of FIG. 7, the door and exterior panels removed. Cabinet frame 800 supports the panels and doors of the cabinet shown in FIG. 7. Components of the RMS are mounted to cabinet frame 800 by vertical rails. Two servers, 802a and 802b are mounted to cabinet frame 800, providing redundant computing services of the RMS. Intelligent power controller 804 controls power to servers 802a and 802b, and a gateway or VPN device not shown. Camera 806 is included in intelligent power controller 804 providing digital pictures of the area in front of the RMS. Temperature sensor 808 is mounted to cabinet frame 800 so that the sensor is inside the fully assembled cabinet. An additional temperature sensor, not shown, is mounted to the top of cabinet frame 800 so that the additional sensor is outside the fully assembled cabinet. Display 810 provides local monitoring facilities of the RMS, the display being connected to one or both of servers 802a and 802b, optionally through a switching device. Keyboard 812, shown by example on a retractable shelf, provides input to servers 802a and 802b, also optionally through a switching device. Indicator lights 814 are provided in intelligent power controller 804 providing viewable status from the front of the RMS through transparent panel 708 shown in FIG. 7.

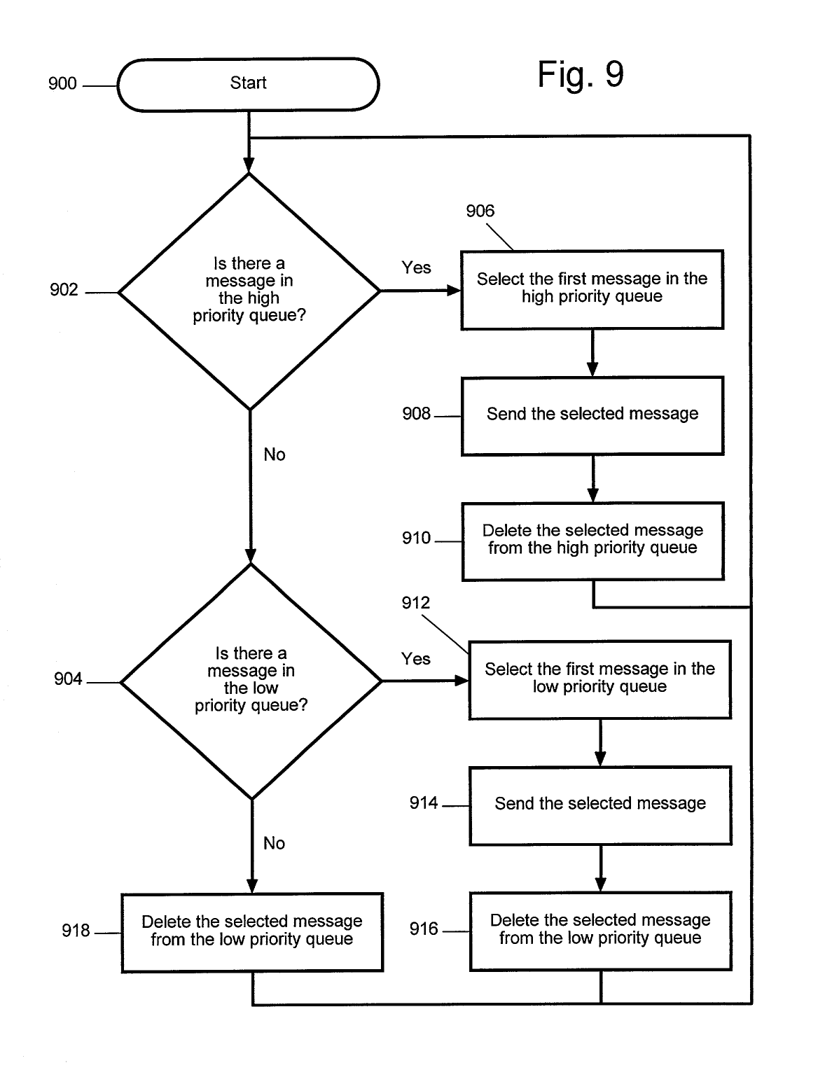

The flowchart of FIG. 9 illustrates by example one method an execution loop whereby messages from enterprise devices may be sent with respect to priority. In this example two message queues, or FIFOs, are implemented, these queues being a high and a low priority queue. Incoming messages from enterprise devices to an RMS will be placed in one of these queues on receipt. The determination of the priority of a message may occur in many ways. One method of assigning priority is prioritizing messages from particular devices over others. Another method is prioritizing messages by content. The message may include a flag or other indication of priority. Elements of the message might be looked up in a table, such table indicating the priority of messages with those particular elements. Those skilled in the art will recognize there are many possible methods of assigning priority.

At the top of the loop, a decision 902 is made as to whether or not there are any messages in the high priority queue. If there are, execution continues to step 906, in which the first, or oldest, message is selected in the high-priority queue. Execution continues from step 906 to step 908, in which the selected message is sent to the superintendent system. Execution then continues from step 908 to step 910, in which the message is removed from the high-priority queue preventing a duplicate sending, following which the loop is repeated at step 902. If there was not a message in the high priority queue on execution of step 902, decision 904 is executed directing further execution on the basis of a message in the low priority queue. If no message is pending, the loop is repeated at step 902, optionally including a delay or task switch in step 918 so unnecessary processor cycles are not consumed. If there is a message in the low priority queue execution proceeds from step 904 to step 912, in which the first, or oldest, message in the low priority queue is selected. Execution proceeds from step 912 to step 914, in which the selected message is sent to the superintendent system. Execution then proceeds from step 914 to step 916, in which the selected message is removed from the low priority queue. Following execution of step 916 the loop is repeated at step 902.

Other priority schemes may permit low priority traffic to be sent at a reduced bandwidth than the high priority traffic. Those skilled in the art will recognize that many useful priority schemes are possible.

In one embodiment of the invention the temperature of the RMS is monitored by one or more temperature sensors. Readings from these temperature sensors is periodically taken and compared to a set range. If a temperature reading is outside that range then a critical priority message is sent to the superintendent system. In a preferred embodiment of the system one temperature sensor is mounted inside the RMS cabinet, monitoring the internal temperature, and another temperature sensor is mounted outside the cabinet, monitoring the exterior temperature.

In another preferred embodiment of the invention the door lock is controlled by SNMP commands sent to an included intelligent power controller. In that embodiment, the door lock is controlled directly by the intelligent power controller. A keypad, being externally accessible, provides for entry of a code to the intelligent power controller whereby the door lock may be disabled. An SNMP command, for example being originated by the superintendent system, may be received by the intelligent power controller, thereby disabling the door lock. A message may be originated by the intelligent power controller to the superintendent system for each disengagement of the door lock.

In one embodiment the camera of the RMS is passive, whereby a digital picture is taken and sent to a requester only on request. In another embodiment, a digital picture is taken each time the door is opened, the picture being saved in an accessible location for future review. In another embodiment, a digital picture is taken each time the door lock is disengaged.

In a preferred embodiment, when a problem is noticed in the RMS a message is sent to the superintendent system. The superintendent system then executes policy for that message which may result in a notification message to a maintainer.

In another preferred embodiment, the servers in an RMS have the Windows NT operating system installed. Agents are installed to the servers which monitor various aspects of the servers status, including memory usage, CPU utilization, and hard drive usage. Another installed agent monitors logs generated by other applications running on the servers and generates messages from the logs. An additional agent monitors the performance of the SQL software. In that embodiment of the invention each server monitors the other servers in its redundant group by listening for a periodic message or signal, which is also known as a heartbeat. When a heartbeat is not received from a server, it is assumed to have become inoperative and the remaining server or servers take over its functionality. Facilities are also provided to maintain synchronous state between the redundant servers.

In a preferred embodiment a database is maintained by the RMS. The database contains the most recent state of the enterprise devices, policy, and optionally the previous state of the enterprise devices. In that preferred embodiment, the RMS filters messages received from enterprise devices using the policy contained in the local database.

In a preferred embodiment of the invention two methods are provided whereby the status of enterprise devices. The first method queries the state maintained in the database of the RMS. The first method is useful for devices which cannot be queried, but rather send state in traps. The second method queries the enterprise devices, the RMS originating queries to report the device status.

In a preferred embodiment the RMS polls enterprise devices in order to detect devices that have become disabled without sending a trap.

Enterprise management applications generally identify events by receiving SNMP messages and by status request polling. These SNMP messages will generally contain information about specific elements and components of a device such as failure conditions, performance information, or other status of the various elements and components. The status request polling generally queries a device periodically in order to obtain similar conditions and status. Status request polling may be though SNMP communication, but may also be through other commonly used or custom means. Enterprise management applications allow for the customization of policy for these messages and polling returns.

An RMS may separate the handling of message and polling returns into two general categories: those that are managed locally and those that are managed at a more global level. The actual separation is accomplished through the configuration of the RMS. In a preferred embodiment the separation is defined by the policy itself. The RMS executes policy for the messages received from the devices and systems being monitored by the RMS. This policy defines actions to be taken, these actions consisting of any possible commands that may be stored in the policy. For example, one action would be to forward the message to another management entity, which might be a superintendent system, another RMS, or any other entity to which such messages may be forwarded. Another example of an action is to restart a managed network device or entity thereby creating an automated response.

A more specific example follows. An RMS monitors and has policy for a virtual private network (VPN) device. The RMS polls the status of the VPN device, noting a failure of the VPN device. When the failure of the VPN device is noticed, the corresponding policy is executed, the policy commanding a restart of the VPN device and forwarding a status message to a superintendent system so maintainers can be made aware of the failure.

Another specific example follows. An RMS monitors and has policy for an enterprise device. The RMS polls the status of the device, noting any failures. The policy directs that new SNMP messages are generated and sent to a superintendent system, the messages noting the failures of the device.

Similarly, in a preferred embodiment the RMS may manage status request messages coming from systems outside the managed enterprise such as a superintendent system, another RMS, other entities that are in communication with the RMS. When that RMS receives a status request message it may request status from the device, and forward the response to the requester. Such an RMS may also report device status from a tracked state, without forming a request to the specific device. Such status request messages and responses may be in the SNMP protocol, but may also use other protocols as desired.

In a preferred embodiment the RMS can interpret messages that are not in the SNMP protocol. In that embodiment the interpretation is performed by an SNMP translator. The SNMP translator translates system messages between SNMP and non-SNMP message types. For example, a system may have facilities for communication through the HTTP protocol and not the SNMP protocol. The SNMP translator contains logic that matches SNMP objects with HTTP message objects so that when the translator receives an HTTP message, it matches the message objects with the corresponding SNMP message objects so that an RMS can use and respond to the message. Such an SNMP translator may be bi-directional such that an RMS can send status requests and event responses to non-SNMP devices and systems. An SNMP translator may handle translation between SNMP and HTTP, CORBA, TCP/IP, XML, and other message protocols.

In the preferred method of installation, the RMS is pre-built and pre-configured before delivery to the site of the managed enterprise. After delivery connections are made to power and to the managed enterprise network. The RMS is then powered on and a configuration menu appears, leading the installer though the remaining installation procedure. The initial inputs to the configuration are the IP address of the superintendent system and local network parameters such as the IP address and mask of the managed network. Following entry of these inputs, the RMS initiates an automated discovery process to identify devices connected to the managed enterprise network. Following the discovery process, initial policy is provided for each discovered device. The installer then may optionally revise the initial policy to better reflect the management functions of the RMS. Such revision might include adjustment of event thresholds and notification information. The RMS then forwards configuration information to the superintendent system and the service is initiated. With the RMS active and connected to the superintendent system forwarding of events, status reports and views, and system updates may take place. System updates may be required when new devices are added to the enterprise system. System updates update the configuration of the RMS such that new devices are included for responses, views, and reports. System updates may be initiated at the RMS or a superintendent system. System updates may also include application updates and revisions, and may also update the associated RMS policy.

In an alternate embodiment the RMS may act to deliver software to enterprise devices. A software update may be deposited to the RMS with instructions to deliver it to specific devices or specific types of devices. An agent running on each device then copies the software update from the RMS and installs it.

An RMS having two or more servers may serve in a redundant fashion, as in a preferred embodiment. Each of the servers are assigned application tasks and serve as cross-connected failover systems. Policy defines the monitoring of the status of the servers, and when failover from one server to another server occurs. That policy may exist in the RMS, and may also exist external to the RMS such as in a superintendent system. For example, the policy may define a performance metric and criteria whereby an acceptable performance level is defined. The performance metric may be in terms of CPU utilization, memory utilization, or other metrics as desired. If the performance of a server falls below the acceptable performance level a sequence of events takes place, as defined by the policy. The policy may specify that an administrator be notified. The policy may also specify that a redundant server take over the functions of a degraded server. The policy may also specify that the degraded server be restarted, and may also specify that management functions be re-enabled.

In a preferred embodiment an RMS may be duplicated at several enterprise sites with minimal effort. That RMS contains two servers acting in a redundant fashion; if one server becomes inoperative the other server is enabled to take over the functions of the RMS. In that embodiment a power controller is included by which the power to each server may be enabled or disabled, through which the servers may be remotely restarted. Also in that embodiment a UPS is provided to mitigate the event of a loss of power. A virtual private network device is provided in that RMS by which an encrypted, secure channel may be provided to the central management facility. That RMS also has a surrounding cabinet with a door and lock to secure the RMS components against tampering or accidental damage. The lock may be disengaged by a command from the central management facility, by entry of a code at a keypad mounted on the exterior of the cabinet, or by a key in the event of loss of power. That RMS also has an internal temperature sensor to monitor the temperature near the RMS components, such as the servers, and an external temperature sensor to monitor the temperature outside the RMS cabinet. In that embodiment a camera is provided that views the main access point of the RMS, which is the front door, so that the identity of persons accessing the RMS can be known. An alarm is also provided in that embodiment which may be activated from the central management facility to notify personnel in proximity of the RMS of a condition in need of attention.

In that preferred embodiment the servers categorize status messages from the enterprise devices into high and low priority groups and submit the information in the messages to the central management facility with respect to priority. Messages from enterprise devices may be delivered through the SNMP protocol or another protocol, and are translated to a format suitable for a notification channel. The enterprise device status may then be delivered to multiple entities with and without the central management facility through the notification channel. In that embodiment the RMS filters enterprise device messages so that only messages deemed important are submitted to the central management facility, and other messages of a trivial nature are not sent to preserve the bandwidth of the communications channel between the RMS and the central management facility. In that embodiment the filtering is provided by policy instructions stored on the RMS. That RMS may receive requests for status from the central management facility and report status either by requesting status of particular enterprise devices or by reporting internally maintained status without immediate communication to the enterprise devices. Requests for status in the preferred embodiment are delivered through a notification channel, wherein the notification channels are used exclusively for communication to and from the RMS outside the enterprise. In that embodiment the RMS also polls status from enterprise devices that do not spontaneously send status reports for all status changes of interest. Facilities for automatic discovery are also provided in that RMS for automatic configuration for the enterprise devices that compose a particular enterprise.

While the present invention has been described and illustrated in conjunction with a number of specific embodiments, those skilled in the art will appreciate that variations and modifications may be made without departing from the principles of the inventions as herein illustrated, described and claimed.

The present invention may be embodied in other specific forms without departing from their spirit or characteristics. The described embodiments are to be considered in all respects as only illustrative, and not restrictive. The scope of the invention is, therefore, indicated by the appended claims, rather than the foregoing description. All changes that come within the meaning and range of equivalency of the claims are to be embraced within their scope.

1. A reporting and maintenance system for remotely monitoring or controlling devices in an enterprise, comprising:
a server group including at least one server;
at least one non-volatile memory device incorporated to said server group;
server network hardware connected to said server group, said server network hardware being configurable to provide electronic communication between said server group and a superintendent system, said server network hardware being further configurable to provide electronic communication between said server group and at least one enterprise device in communicative proximity;
first computer readable instructions installed to said memory devices, said first instructions providing the function of receiving first messages from enterprise devices in at least one enterprise management protocol;
second computer readable instructions installed to said memory devices, said second instructions providing the function of forwarding the information contained in the first messages to a superintendent system;
and third computer readable instructions installed to said memory devices, said third instructions providing the function of filtering the first messages, the filtering preventing the forwarding of some of the first messages.

2. The system of claim 1, further comprising:
fourth computer readable instructions installed to said memory devices, said fourth instructions providing the function of assigning priority to the information in said first messages;
and said second instructions provide the function of forwarding the information contained in the first messages in preferential order by the assigned priority.

3. The system of claim 1, further comprising:
fourth computer readable instructions installed to said memory devices, said fourth instructions performing the functions of:
(i) maintaining a high and a low priority queue,
(ii) sending messages from the high priority queue before messages from the low priority queue,
and (iii) deleting messages from the queues when the messages have been sent.

4. The system of claim 1, further comprising:
fourth computer readable instructions installed to said memory devices, said instructions providing the function of translating the first received messages to a second protocol.

5. The system of claim 1 wherein the first messages are communicated using version 1 of the simple network management protocol.

6. The system of claim 1 wherein the forwarding of the first messages includes transmitting the information of the first messages through a notification channel.

7. The system of claim 1 wherein the filtering of the first messages is prescribed through policy.

8. The system of claim 1, further comprising:
a gateway included in said server network hardware configurable to provide communication between said server group and a superintendent system.

9. The system of claim 1, wherein said server network hardware is configurable to provide encrypted communication between said server group and a superintendent system.

10. The system of claim 1, further comprising:
a network enabled temperature sensor, said temperature sensor positioned to monitor the temperature of the air in proximity of said server group.

11. The system of claim 1, further comprising:
a cabinet housing said server group.

12. The system of claim 11, further comprising:
a network enabled temperature sensor, said temperature sensor positioned to monitor the temperature of the air outside said cabinet.

13. The system of claim 11, further comprising:
at least one door included in said cabinet whereby access to said server group is restricted when said doors are in closed position;
locks included in said doors whereby said doors may be secured in a closed position.

14. The system of claim 13 wherein at least one of said locks may be disabled through an electronic command message from a superintendent system.

15. The system of claim 13, further comprising:
a data entry device connected to at least one of said locks, said data entry device being mounted to said cabinet, said data entry device providing a human interface external to the cabinet enclosure;
at least one of said locks may be disabled through said data entry device.

16. The system of claim 1, further comprising:
a network enabled camera whereby a space in proximity to said server group may be monitored.

17. The system of claim 1, further comprising:
an alarm in proximity to said server group.

18. The system of claim 1, further comprising:
a network enabled power controller connected to and being configurable to control the power of at least one server of said server group, said power controller being configurable to accept network commands from a superintendent system.

19. The system of claim 1, further comprising:
fourth computer readable instructions installed to said memory devices, said instructions providing the function of receiving second messages from a superintendent system, said second messages referencing at least one enterprise device;
fifth computer readable instructions installed to said memory devices, said instructions providing the function of forwarding the information in the second messages to the referenced enterprise devices.

20. The system of claim 19, further comprising:
sixth computer readable instructions installed to said memory devices, said instructions providing the function of translating the second received messages to an enterprise management protocol utilized by the referenced enterprise devices.

21. The system of claim 19 wherein the second messages are communicated using version 1 of the simple network management protocol.

22. The system of claim 19 wherein the second messages are received through a notification channel.

23. The system of claim 19, further comprising:
sixth computer readable instructions installed to said memory devices, said instructions providing the function of translating the second received messages to an enterprise management protocol utilized by the referenced enterprise devices.

24. The system of claim 1, further comprising:
enterprise devices in electronic communication with said server group through said server network hardware.

25. The system of claim 1, further comprising:
a superintendent system in electronic communication with said server group through said server network hardware.

26. The system of claim 1, further comprising:
fourth computer readable instructions installed to said memory devices, said fourth instructions providing the function of accepting network parameters that define the boundaries of an enterprise, said fourth instructions also providing the function of discovering enterprise devices through said server network hardware using the network parameters.

27. The system of claim 1, further comprising:
fourth computer readable instructions installed to said memory devices, said fourth instructions providing the function of receiving a software upgrade from a superintendent system, said fourth instructions also providing the function of delivering the software upgrade to enterprise devices.

28. The system of claim 1 wherein said server group includes two or more servers, the servers providing redundancy.

29. A reporting and maintenance system for remotely monitoring or controlling devices in an enterprise, the devices communicating in at least one enterprise management protocols, said reporting and maintenance system comprising:
a server group including at least one server;
at least one non-volatile memory device incorporated to said server group;
server network hardware connected to said server group, said server network hardware being configurable to provide electronic communication between said server group and a superintendent system, said server network hardware being further configurable to provide electronic communication between said server group and at least one enterprise device in communicative proximity;
first computer readable instructions installed to said memory devices, said instructions providing the function of receiving status requests from a superintendent system, said requests referencing at least one enterprise device;
second computer readable instructions installed to said memory devices, said instructions providing the function of forwarding the requests to the referenced enterprise devices in at least one enterprise management protocol;
third computer readable instructions installed to said memory devices, said first instructions providing the function of receiving response messages from enterprise devices in at least one enterprise management protocol;
and fourth computer readable instructions installed to said memory devices, said second instructions providing the function of forwarding the information contained in the response messages to a superintendent system.

30. The system of claim 29, further comprising:
fifth computer readable instructions installed to said memory devices, said instructions providing the function of translating the requests to an enterprise management protocol utilized by the referenced enterprise devices.

31. The system of claim 29, further comprising:
fifth computer readable instructions installed to said memory devices, said instructions providing the function of translating the response messages to an enterprise management protocol utilized by the superintendent system.

32. The system of claim 29 wherein communication of requests and responses to the enterprise devices is through version 1 of the simple network management protocol.

33. The system of claim 29 wherein communications of requests and responses to the superintendent system is through a notification channel.

34. The system of claim 29, further comprising:
sixth computer readable instructions installed to said memory devices, said instructions providing the function of translating the requests to an enterprise management protocol utilized by the referenced enterprise devices, said instructions further providing the function of translating the response messages to a notification channel protocol.

35. A reporting and maintenance system for remotely monitoring or controlling devices in an enterprise, comprising:
a server group including at least two servers, said servers providing redundancy of operation;
at least one non-volatile memory device incorporated to said server group;
server network hardware connected to said server group, said server network hardware including a gateway, said server network hardware being configurable to provide encrypted electronic communication between said server group and a superintendent system through said gateway, said server network hardware being further configurable to provide electronic communication between said server group and at least one enterprise device in communicative proximity;
first computer readable instructions installed to said memory devices, said first instructions providing the function of receiving first messages from enterprise devices in at least one enterprise management protocol including version 1 of SNMP;
second computer readable instructions installed to said memory devices, said second instructions providing the function of forwarding the information contained in the first messages to a superintendent system by a notification channel in preferential order by an assigned priority;
third computer readable instructions installed to said memory devices, said third instructions providing the function of filtering the first messages, the filtering preventing the forwarding of some of the first messages, said filtering prescribed by policy;
fourth computer readable instructions installed to said memory devices, said fourth instructions providing the function of assigning priority to the information in said first messages;
fifth computer readable instructions installed to said memory devices, said instructions providing the function of translating the first received messages to a second protocol;
a cabinet housing said server group;
a first network enabled temperature sensor, said first temperature sensor positioned to monitor the temperature of the air at the interior of said cabinet;
a second network enabled temperature sensor, said second temperature sensor positioned to monitor the temperature of the air outside said cabinet;
at least one door included in said cabinet whereby access to said server group is restricted when said doors are in closed position;
locks included in said doors whereby said doors may be secured in a closed position, said locks enabled to unlock through an electronic command message from a superintendent system;
a data entry device connected to said locks, said data entry device being mounted to said cabinet, said data entry device providing a human interface external to the cabinet enclosure; said locks enabled to be unlocked through said data entry device;
a network enabled camera whereby a space in proximity to said server group may be monitored;
an alarm in proximity to said server group;
a network enabled power controller connected to and being configurable to control the power of at least one server of said server group, said power controller being configurable to accept network commands from a superintendent system;
sixth computer readable instructions installed to said memory devices, said instructions providing the function of receiving second messages from a superintendent system through a notification channel, said second messages referencing at least one enterprise device;
seventh computer readable instructions installed to said memory devices, said instructions providing the function of translating the second received messages to an enterprise management protocol utilized by the referenced enterprise devices;
eighth computer readable instructions installed to said memory devices, said instructions providing the function of forwarding the information in the second messages to the referenced enterprise devices in at least one enterprise management protocol including version 1 of the simple network management protocol;
enterprise devices in electronic communication with said server group through said server network hardware
a superintendent system in electronic communication with said server group through said server network hardware
ninth computer readable instructions installed to said memory devices, said ninth instructions providing the function of accepting network parameters that define the boundaries of an enterprise, said ninth instructions also providing the function of discovering enterprise devices through said server network hardware using the network parameters;
and tenth computer readable instructions installed to said memory devices, said tenth instructions providing the function of receiving a software upgrade from a superintendent system, said tenth instructions also providing the function of delivering the software upgrade to enterprise devices.
